(19) United States
(12) Patent Application Publication
(10) Pub. No.: US 2012/0259704 A1
(43) Pub. Date: Oct. 11, 2012

(54) TIME-SENSITIVE AND LOCATION-BASED COMMERCIAL OFFER SYSTEM

(76) Inventor: Dante Monteverde, Las Vegas, NV (US)

(21) Appl. No.: 13/292,428

(22) Filed: Nov. 9, 2011

Related U.S. Application Data
(63) Continuation-in-part of application No. 13/082,008, filed on Apr. 7, 2011.

(51) Int. Cl. G06Q 30/02

(52) U.S. Cl. 705/14.58; 705/14.49

(57) ABSTRACT

A method, system, apparatus and computer program to notify a user of a commercial offer that is time-sensitive and time-specific. The user can be notified of commercial offers associated with locations near the user's current or predicted location. The commercial offers are time-specific, for example, a commercial offer for breakfast that can only be used during morning hours. As such, the commercial offers can be provided to consumers that are commonly located in the area of the vendor offering the commercial offer at the time of day in which the commercial offer is most relevant.

### CROSS REFERENCE TO RELATED APPLICATION

The present application is a continuation-in-part of U.S. patent application Ser. No. 13/082,008, filed Apr. 7, 2011, the contents of which are hereby incorporated by reference in their entirety.

### TECHNICAL FIELD OF THE INVENTION

The present invention relates generally to commercial offers from vendors, and more specifically to time-sensitive or specific commercial offers that are presented to a consumer likely to be located near the vendor during the time in which the commercial offer is most relevant.

### BACKGROUND OF THE INVENTION

Internet-based “deal of the day” coupon offerings have become popular in recent years. Discounts of this sort are typically sent in deal of the day coupons to members of a predetermined list. If a sufficient number of people agree to the group discount, the group discount becomes available to all members of the list. However, if the predetermined threshold of people do not agree to the group coupon, the deal will not become available to the members of the list. This business model has been successful in that it allows a large group to receive discounted offers for products or services, while allowing businesses to require a predetermined number of users to accept the discount so that their product or service may be sold in bulk.

The above conventional methods are typically not targeted to a particular geographic area or, at best, are targeted to a general metropolitan area (e.g., the Chicago metropolitan area). As a result, conventional coupon distribution systems are not tailored to areas where a particular buyer would typically travel on a routine basis. The potential buyer is thus frequently subjected to offers from businesses not located within his or her most commonly traveled areas.

Also, the typical commercial offers are not tied to the specific habits or routine of the user, nor do the commercial offers focus on the time-specific nature of the offer. For example, the conventional online coupon is not targeted to specific users that are likely to be in a location of the vendor presenting the coupon at a time in which the coupon would be most relevant. The vendor cannot adequately target such users who may accept a commercial offer for a service that is time-specific, such as a coffee discount, which would likely be time-specific to the morning hours. The user may be located at or near the vendor during the morning hours consistent with the user's routine, but would not be informed of the time-specific offer during the relevant time period and thus would not take advantage of the commercial offer.

By their nature, group coupon deals encourage users to recommend the coupon to their peers so that a required minimum number of users utilize the deal, thereby increasing the vendor's customer base exposure. In other words, customers who purchased the deal generate additional customers for the vendor by “word of mouth” advertising in order to ensure that the minimum number of group coupons will be sold and the group coupon will be usable. Therefore, the conventional group coupon system uses the fear of a possible failed deal as a marketing technique to increase the number of purchasing customers for the vendor. However, this incentive can sometimes work too well—producing a large increase of customers for the vendor for a short period of time, which can overwhelm the vendor during the relevant coupon period (e.g., the vendor does not have adequate staffing or inventory to meet the coupons' demand).

### BRIEF SUMMARY OF THE INVENTION

The present application discloses a system that targets a user with time-specific commercial offers based on the location and time-based routines of the user. The user can be notified of commercial offers associated with a particular offer area that the user is frequently located in at a point in time that is relevant to the commercial offers, for example, a commercial offer for breakfast that can only be used during the morning hours. In an embodiment, the system uses a statistical analysis to anticipate the user's location and time in order to specifically target the user as a likely candidate for the commercial offer. As such, the commercial offers can be provided to consumers that are commonly located in the area of the vendor offering the commercial offer at the time of day in which the commercial offer is most relevant.

The present application also discloses a system and method where coupons or other advertisements are transmitted to potential customers in a controlled time-released fashion to minimize the possibility of overwhelming the staff and/or inventory of the vendor during the time period that the coupon can be utilized. In an embodiment, sets of coupons or advertisements can be available for distribution, wherein a first set can be distributed to a first subset of users during a pre-selected time period. Then, during a different pre-selected time period, a second set can be distributed to a second subset of customers. The deal can be then be sent to groups of customers over selected and controlled periods of time, rather than simultaneously transmitting the offer to all customers and overwhelming the vendor with a large surge in business.

In another embodiment, the sets of coupons or advertisements can be simultaneously transmitted to all customers, but each of the sets of coupons or advertisements has different time periods of usability. For example, a first set of coupons sent to a first subset of customers may be usable only on Monday, wherein a second set of coupons sent to a second subset of customers may be usable only on Tuesday, even though both subsets of customers received the coupon or advertisement at the same time. The time-released deal system can further require that the customer refer the deal to a predetermined number of other customers before the customer can utilize the deal, in a sort of recruitment program.

In particular, the present application discloses a method of providing a commercial offer including establishing a location trend of a user representing an estimated time when the user will be located within an anticipated location; determining a commercial offer that coincides with the location trend; and providing the commercial offer to the user based on the time in which the user will be located near the anticipated location.

The present application also discloses a method of providing a commercial offer including recording a location of a user at predetermined intervals to establish a location trend; analyzing the location trend to determine a probability score indicating the probability of the user being in the location at the predetermined interval; determining whether the probability score is above a predetermined threshold; obtaining a commercial offer from a vendor, wherein goods or services associated with the commercial offer can only be obtained during an offer period; and transmitting the commercial offer to the user if the probability score is above a predetermined threshold.

### BRIEF DESCRIPTION OF THE DRAWINGS

For the purpose of facilitating an understanding of the subject matter sought to be protected, there is illustrated in the accompanying drawing embodiments thereof, from an inspection of which, when considered in connection with the following description, the subject matter sought to be protected, its construction and operation, and many of its advantages should be readily understood and appreciated.

FIG. 1 is a schematic diagram of an embodiment of the present invention;

FIG. 2 is a schematic diagram illustrating the hardware components of an embodiment of a user device of the present invention;

FIG. 3 is a flow chart of an embodiment of the present invention depicting a method for presenting relevant commercial offers to a user;

FIG. 4 is a flow chart of an embodiment of the present invention depicting a method for determining a geographic point of interest of the user;

FIG. 5 is a flow chart of an embodiment of the present invention depicting a method for determining a target area based on the established geographic points of interest of the user;

FIG. 6 is a flow chart of an embodiment of the present invention depicting a method of presenting relevant commercial offers to a user based on a pre-established target area of the user;

FIGS. 7(a)-(c) are illustrations of a display showing several geographic points of interest of the user;

FIG. 8(a) is an illustration of a display showing a user-modified target area based on the user-inputted geographic points of interest;

FIG. 8(b) is an illustration of a display showing a completed custom target area;

FIG. 9 is a flow chart of a method of providing a commercial offer to a user; and

FIG. 10 is another flow chart of a method of providing a commercial offer to a user.

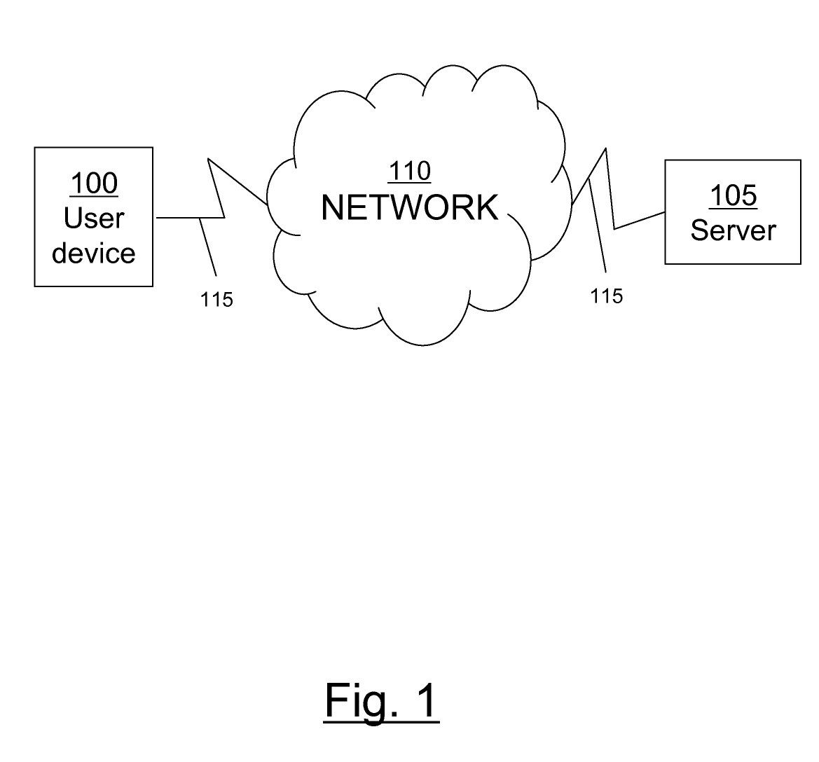

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

The present application discloses an apparatus, method, system and computer program for facilitating commercial transactions between businesses and users located within a custom-designated target area. In an embodiment, a user device 100 may be connected to a server 105 via a network 110 by way of communication links 115, such as, for example, the Internet. The user device 100 communicates with the server 105 to transmit data to and receive data from the server 105. Such data can include, for example, search queries from the user, commercial offers received from the server 105 to the user device 100, the vendor's position in the search results based on a pay-for-placement auction, counteroffers from the user device 100 to the server 105, and data that depicts the geographic points of interest of the user or the target area of the user.

As used herein, the term “pay-for-placement” can refer to an auction or flat payment transaction where a vendor can bid on the placement of a link to their website or commercial offer within a string of search results. A higher bid from the vendor can cause a link to the website to be displayed prominently within the search results, e.g., by displaying the link first or near the top of the list of search results, by displaying the link in font larger than font used to display links to websites of lower bids, by placing higher bid links in bold, underline or italics, by displaying the name of higher bid links in a color more visible to a user (e.g., red), or by displaying higher bid links using a picture while lower bid links are displayed in text only, for example. Any other manner of displaying images or text more prominently can be used within the pay-for-placement auction without departing from the spirit and scope of the present application.

As used herein, the term “bid” can refer to a flat amount of money paid to the search engine or a portion of the discount offered to the consumer (e.g., a dollar amount). In an embodiment, instead of paying the search engine a guaranteed amount of money, a vendor can also “bid” for placement by offering a portion of the discount offered to the buyer, referred to herein as a discount proposal. In this exemplary pay-for-placement auction, the commercial offers will be displayed in an order corresponding to the discount amount offered (i.e., highest discount first, second highest discount second, and so forth). The search engine can receive a commission as a portion of the discount offered to the potential buyer. For example, if a buyer searches for pizza within his or her target area, and Domino's® Pizza offers a ten dollar discount compared to a five dollar discount offered by Papa Johns® Pizza, Domino's® discount will be displayed first. However, of the ten dollar discount offered by Domino's®, five dollars will be distributed to the potential buyer and five dollars will be distributed to the search engine as a commission. Of course, the commission can be any amount of the discount offered to the potential buyer.

Commercial offers can include any offer from a vendor or consumer that is capable of being transmitted over the network 110, or any representation of the vendor's business. As used herein, a consumer offer can be a listing of a link to a website in a list of search results, a coupon offer, a list of prices for relevant products or services, or any other means of communicating a potential commercial transaction. The commercial offers are typically provided from vendors located in the user's target area, but commercial offers from any vendor can be distributed to the user without departing from the spirit and scope of the present application.

Geographic points of interest to the user can include any geographic point and can be determined either manually by user input or automatically if the user has not input any custom geographic points of interest. By way of example, common geographic points of interest may include the location of the user's home, the location of the user's work, the location of the user's children's school, the location of the user's church, synagogue, mosque, or other place of worship, restaurants or other businesses commonly frequented by the user, or any other location that may help define the routine of the user and/or the locations where the user is likely to do business. It will be understood that the intent is that the preferred geographic points of interest are those points where the user typically travels to and/or from, although any points of interest can be included, such as, for example, a location where the user is going on a vacation. As discussed below, based on the geographic points of interest of the user, the embodiments of the present application determine a target area that more closely identifies an area that the user is likely to frequent and conduct business. Accordingly, pay-for-placement bids and coupon offers can be more closely tailored to a target consumer audience that is more likely to accept the commercial offers of, or conduct business with, the vendor.

The user device 100 can be a device of any type that allows for the transmission and/or reception of data. By way of example, the user device 100 can include a smart phone (e.g. iPhone®), personal computer, voice and video telephone set, streaming audio and video media player, integrated intelligent digital television receiver, DVS receiver, work station, radio, personal digital assistant (PDA), mobile satellite receiver, GPS receiver, software system, social network or any combination of the above.

The server 105 can also be a device of any type that allows for the transmission and/or reception of data, and that is capable of storing information to be transmitted to the user device 100. For example, the server 105 can include any device listed above with respect to the user device 100, or can include a non-transitory computer-readable recording medium, such as a hard drive, DVD, CD, flash drive, volatile or non-volatile memory, RAM, or any other type of data storage.

The network 110 may be a single network or a plurality of networks of the same or different type. For example, the network 110 may include a local telephone network (such as a Bell Atlantic telephone number) in connection with a long distance network (such as an AT&T long distance telephone network). Further, the network 110 may be a data network, an Intranet, the Internet or a telecommunications network in connection with a data network. Any combination of telecommunications and data networks may be used without departing from the spirit and scope of the present application. For purposes of discussion, it will be assumed that the network 110 is the Internet.

The communication links 115 may be any type of connection that allows for the transmission of information. Some examples include conventional telephone lines, fiber optic lines, direct serial connections, cellular telephone connections, satellite communication links, local area networks (LANs), intranets, and the like.

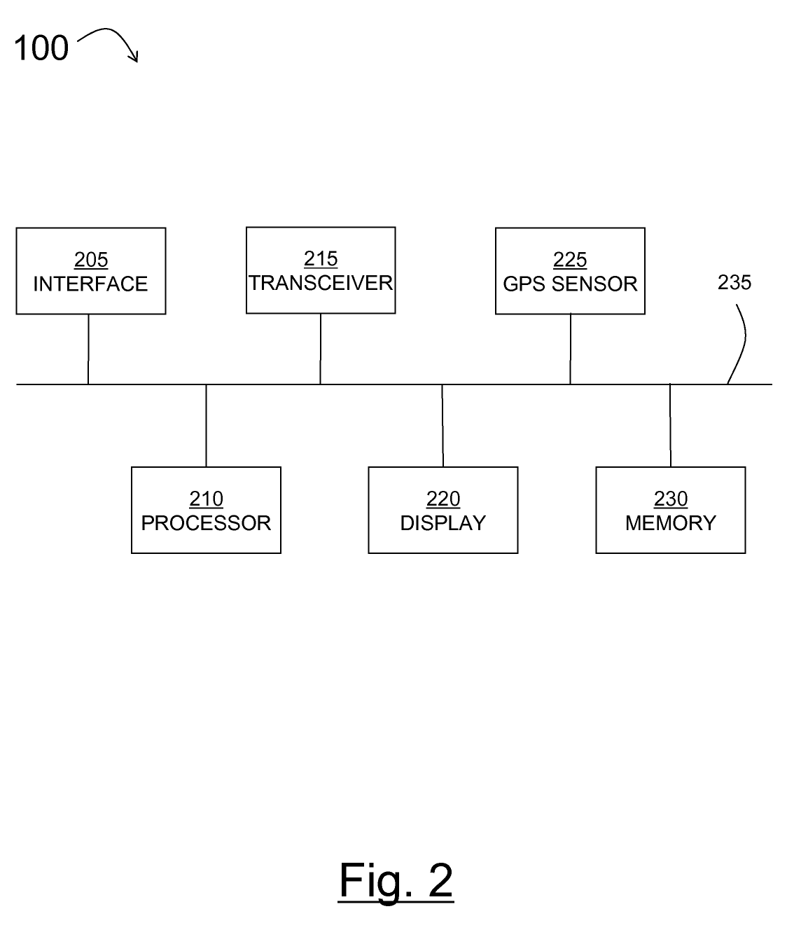

FIG. 2 is a schematic diagram illustrating hardware components of a user device 100 using an embodiment of the present invention. As shown, the user device 100 can include an interface 205, processor 210, transceiver 215, display 220, GPS sensor 225 and a memory 230 connected via a bus 235.

The interface 205 allows the user to input information or commands into the user device 100 and to transmit the information or command to the server 105 via the network 110. By way of example, the interface can include a keyboard, mouse, touch screen, audio recorder, audio transmitter, member pad, or any other device that allows for the entry of information from a user.

The processor 210 facilitates communication between the various components of the user device 100. The processor 210 can be any type of processor or processors that alone or in combination facilitate communication within the user device 100 and, together with the transceiver 215, are adapted to transmit information from the user device 100 to external devices. For example, the processor 210 can be a desktop or mobile processor, a microprocessor, a single-core or a multi-core processor.

The transceiver 215 can be any device capable of transmitting data from the user device 100 or capable of receiving data within the user device 100 from an external data source. By way of example, the transceiver 215 can be any type of radio transmission antenna, cellular antenna, hardwired transceiver, or any other type of wired or wireless transceiver capable of communicating with an external device.

In an embodiment, the display 220 can display various information for the user to view and interpret, including commercial offers, a search engine interface, search engine results, or requests for the user to input information via the interface 205. By way of example, the display 220 can include a liquid crystal display (LCD), organic light emitting diode (OLED) display, plasma screen, cathode ray tube display, or any other kind of black and white or color display that will allow the user to view and interpret information on the user device 100. In an embodiment, the GPS sensor 225 is provided and can allow the user device 100 to determine its current GPS coordinates and thus determine the user's geographic orientation. As discussed below, the GPS coordinates of the user device 100 can be used to determine various geographic points of interest of the user without having to prompt the user to manually input such geographic points of interest.

As used herein, the term “geographic points of interest” can include any geographic point and can be determined either manually by user input or automatically if the user has not input any custom geographic points of interest. By way of example, common geographic points of interest may include the location of the user's home, the location of the user's work, the location of the user's children's school, the location of the user's church, synagogue, mosque, or other place of worship, restaurants or other businesses commonly frequented by the user, or any other location that may help define the routine of the user and/or the locations where the user is likely to do business. It will be understood that the intent is that the preferred geographic points of interest are those points where the user typically travels to and/or from, although any points of interest can be included, such as, for example, a location where the user is going on a vacation.

As discussed below, based on the geographic points of interest of the user, the embodiments of the present application determine a target area that more closely identifies an area that the user is likely to frequent and conduct business. Accordingly, pay-for-placement bids and coupon offers can be more closely tailored to a target consumer audience that is more likely to accept the commercial offers of, or conduct business with, the vendor.

In an embodiment, the memory 230 can store any information including commercial offers or search results received from the server 105 via the network 110. The memory 230 can also store an operating system for the user device 100 or any other software or data that may be necessary for the user device 100 to function. Similar to the server 105 discussed above, the memory 230 can include any non-transitory computer-readable recording medium, such as a hard drive, DVD, CD, flash drive, volatile or non-volatile memory, RAM, or any other type of data storage.

In an embodiment, the bus 235 acts as the internal circuitry of the user device 100 that electrically connects the various hardware components of the user device 100. The bus 235 can be any structure that performs such a function.

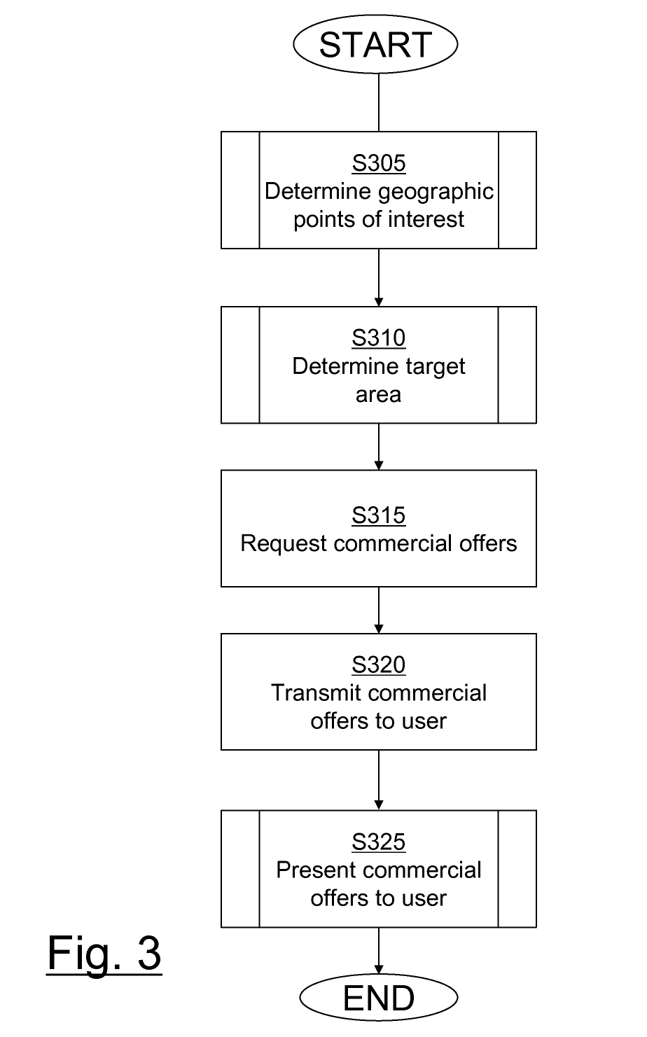

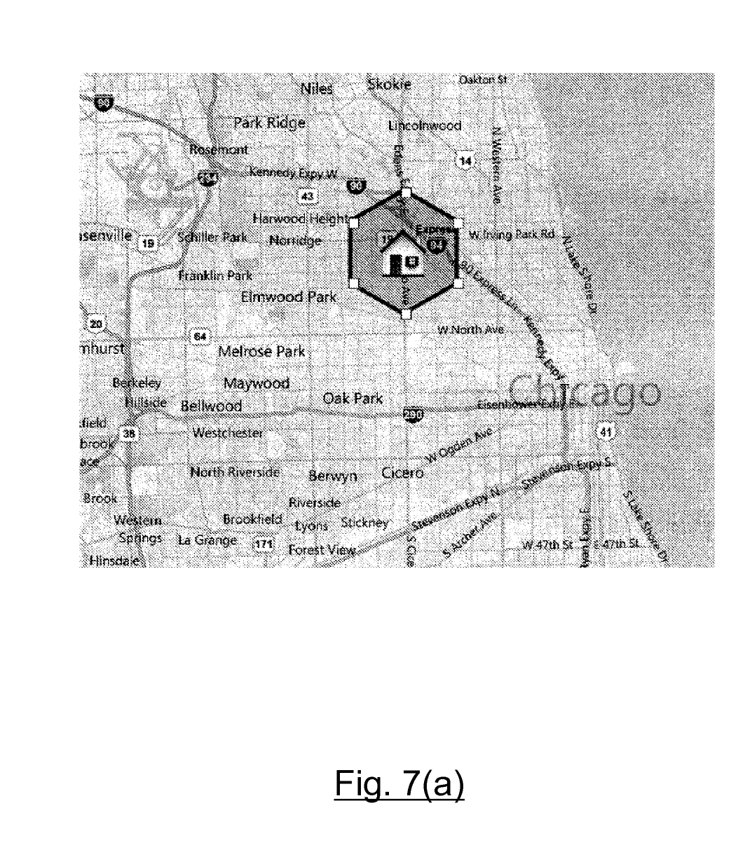

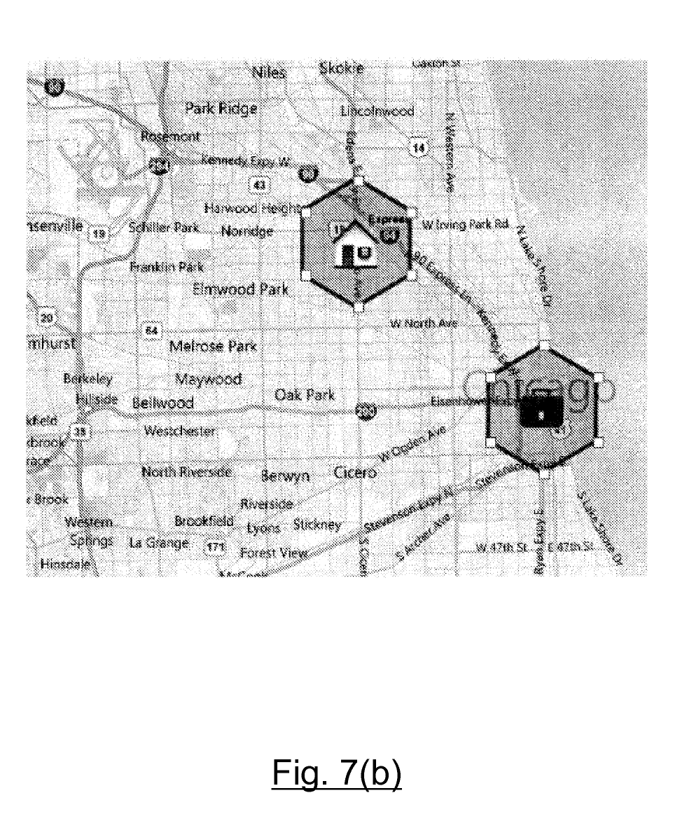

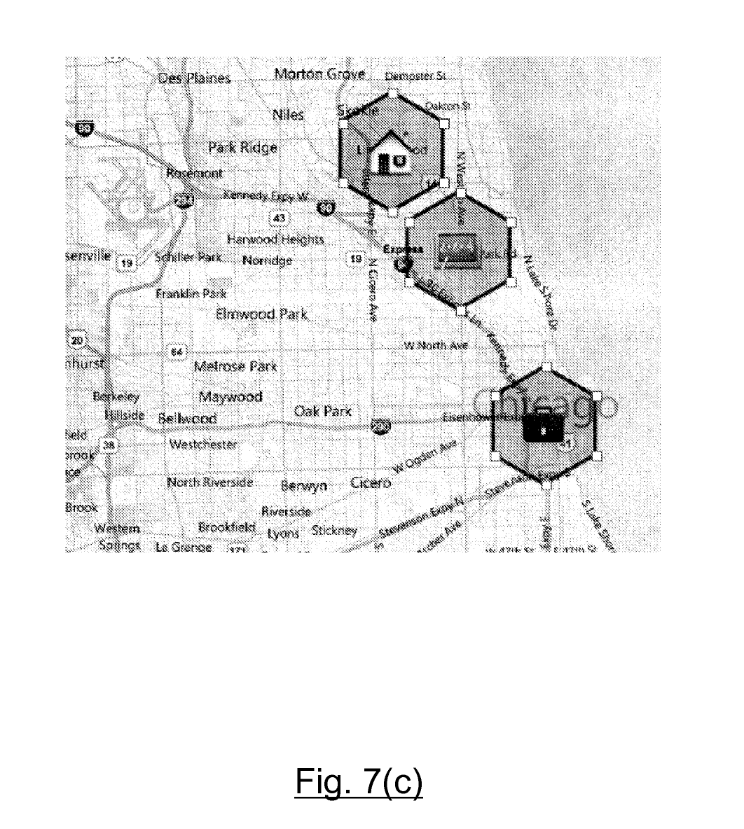

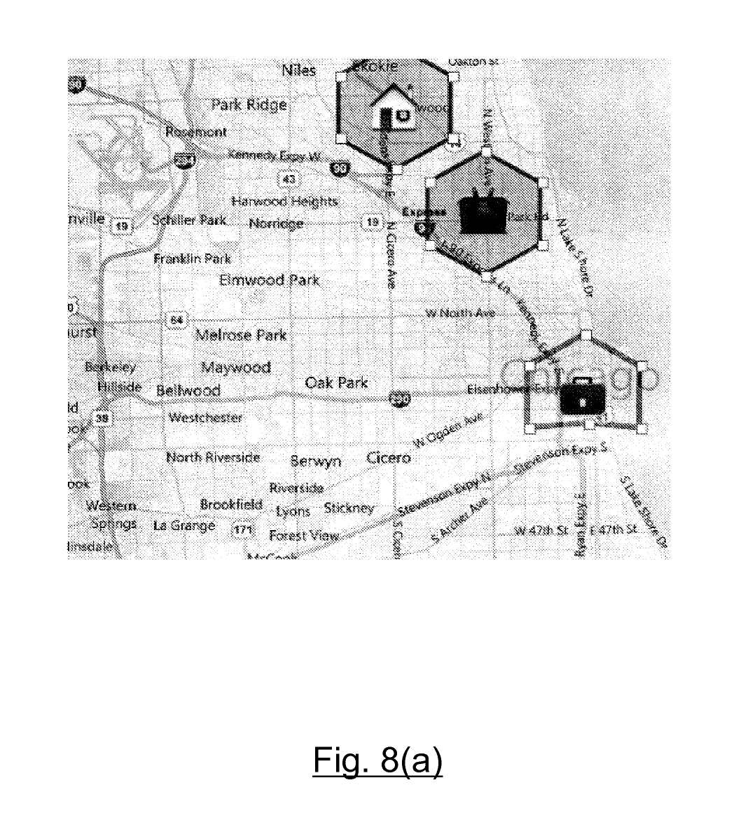

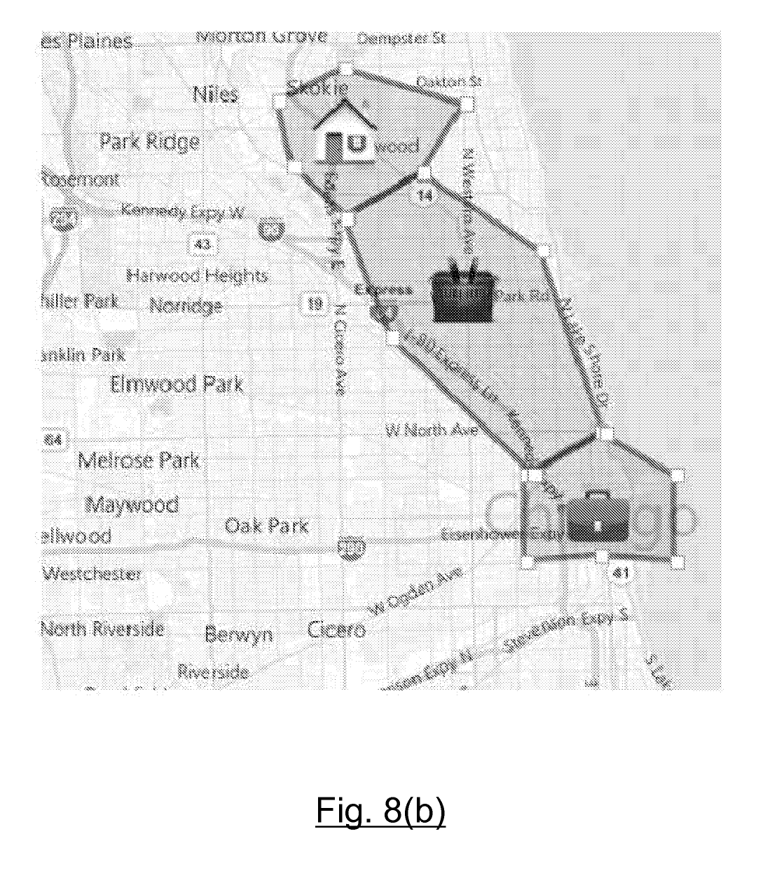

FIG. 3 discloses a flow chart depicting an embodiment of the present invention in which commercial offers are transmitted and presented to relevant potential buyers based on their preferred, typical geographic points of travel. The process starts at S305, where geographic points of interest are determined by either manually asking the user to input the geographic points of interest or by automatically determining the geographic points of interest based on various factors. As discussed above, the geographic points of interest represent specific locations in which the user is likely to travel based on his or her routine and/or based on areas that the user commonly frequents. Moreover, the geographic points of interest can be modified by typical click-and-drag capabilities and can be represented in any shape. Therefore, while the geographic points of interest are shown as hexagonal in FIGS. 7 and 8, it will be appreciated that other shapes can be used, such as, for example, circular, square, rectangular or polygonal. Moreover, the size of the shape can be modified in order to better represent the relevant geographic search area. For example, a circular shape could represent a 5-mile radius from a particular point of interest, wherein businesses within the 5-mile radius would have their results displayed to the user, and businesses outside of the 5-mile radius would not be displayed since it is unlikely the user would conduct business with that business. Moreover, the points of interest can further be interconnected to designated preferred travel corridors when the user travels between the different points of interest. For example, the home point of interest can be interconnected with the work point of interest, wherein geographically relevant businesses along the designated travel route may be provided to the user.

Once the geographic points of interest are established in S305, the process proceeds to S310, where the target area can be determined based on the established geographic points of interest. The target area can be an area that depicts where the user frequently is located or travels based on his or her routine in a broader sense than that depicted in S305 with respect to the geographic points of interest. As discussed below, the target area may be modified by the user or may be automatically modified by the user device 100 to provide a more narrowly tailored target area for the particular user.

Once the target area has been determined in S310, commercial offers can be requested in S315 by the user device. For example, the user device 100 can enter various search terms into a search engine so as to request commercial offers or business websites in the particular search engine. Alternately, the user device 100 can request commercial offers through an on-demand type methodology in which the user knows in advance from which vendor he or she would like to request a commercial offer. Although FIG. 3 illustrates the user entering various search terms in a search engine after the target area has been established, the order of this process can vary. For example, the user can enter search queries prior to establishing a target area, or the user can be sent the commercial offer without any search being conducted. In accordance with a group coupon delivery model, the user could purchase the commercial offer and, if enough of the commercial offers are purchased from other users, the commercial offer will be honored by the vendor.

After the commercial offers have been requested in S315, the commercial offers for vendors located in the target area where the user is located or commonly travels can be transmitted to the user in S320. The transmitted commercial offers can originate either from the server 105 or anywhere else within the network 110, for example, on an external user device 100 within a peer-to-peer network.

Once the commercial offers are transmitted to the user in S320, the commercial offers can be presented to the user in S325. The manner in which the commercial offers are presented to the user is not limited, and can include displaying the commercial offers on the display 220 or emitting an audio signal communicating the commercial offers. Once the user receives and hears or views the commercial offer, the user can accept the offer by traveling to the location of the business within the target area or by electronically accepting the offer on the user device 100. The commercial offers can be for vendors that are located in an area that is at or near an area that the user commonly frequents at a predetermined time of day. For example, the commercial offer can be for a discounted coffee based on the knowledge that the user is likely to be located near the vendor during the morning hours. The user can thus be more closely targeted based on the daily, weekly, or otherwise periodic routines that link the user to a particular area at a particular time.

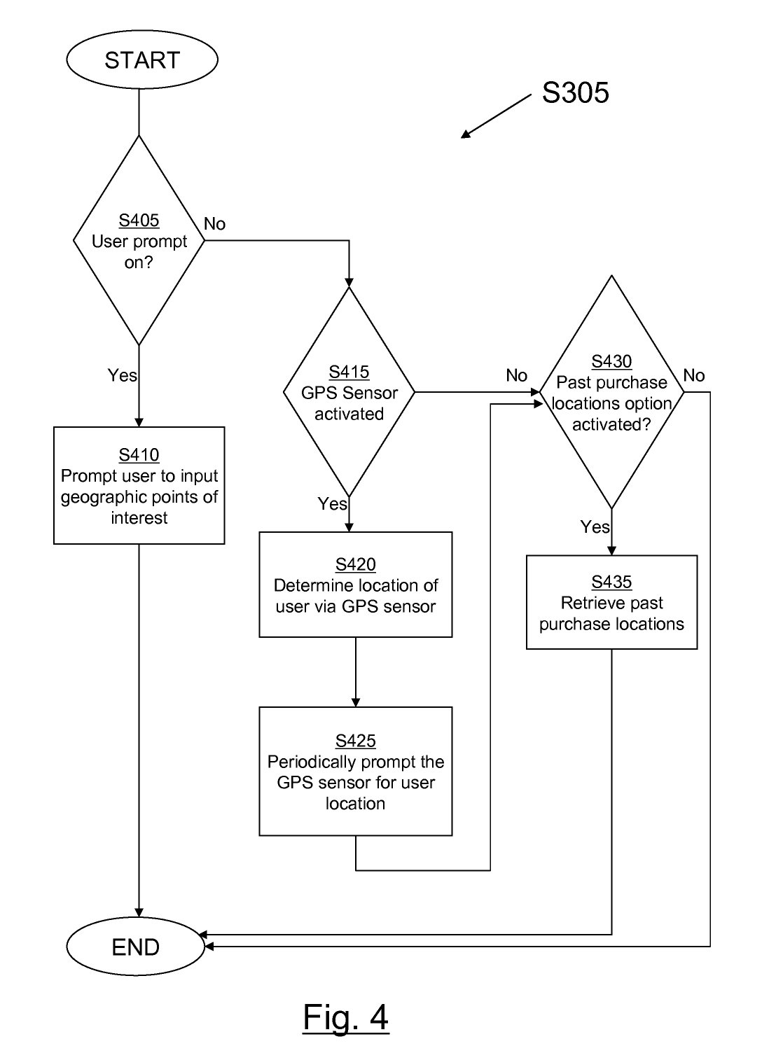

FIG. 4 is a flow chart illustrating a more detailed description of S305, in which geographic points of interest are determined. The process starts at S405, where it is determined whether a user prompt is currently activated. If the user prompt is activated, the process proceeds to S410 where the system prompts the user to input geographic points of interest. For example, the system may prompt the user to input a location of the user's home, the user's work, the location of the user's children's school, or any other locations that the user frequently visits. After the user enters the geographic points of interest, the manually input geographic points of interest are established as the geographic points of interest and the process according to S305 ends.

If the user prompt is not activated, the user device 100 can automatically determine geographic points of interest based on various factors discussed below. Each of these factors may be toggled on or off as desired by the user to provide a more custom-tailored list of geographic points of interest. For example, as shown in FIG. 4, if the user prompt is not on, the process may determine whether the GPS sensor has been activated in S415. If the GPS sensor has been activated, the process may proceed to S420, in which the location of the user is determined via the GPS sensor. The user location determined in S420 can be established as a geographic point of interest either separate from or in addition to other geographic points of interest established based on other factors. Alternately, or in addition to the above, the server 105 and/or the network 110 can prompt the GPS sensor for the user location, as depicted in S425. Following this process, or if the GPS sensor is not activated, the process proceeds to S430.

In S430, it is determined whether a past purchase locations option has been activated within the user device. In an embodiment, this option is adapted to determine the past locations that the user has purchased goods or services under the assumption that a user is more likely to purchase goods or services in locations where he or she has previously conducted consumer transactions. If the past purchase locations option is activated, the process proceeds to S435 where the user device 100 retrieves past purchase locations from the server 105, the memory 230, or another storage device within the network 110. For example, the user device 100 may store in the memory 230 various purchase locations that were manually or automatically input into the memory 230. The user device 100 can also retrieve from the server 105 or another data storage device on the network 110 information from the user's credit card company, bank, or other commercial organization (e.g., PayPal®) to determine the location in which the user purchased items in the past. Once the geographic point of interest has been determined in S435, the process according to S305 ends. Alternately, if the past purchase locations option is not activated, the process according to S305 ends without attempting to retrieve the past purchase locations as depicted in S435.

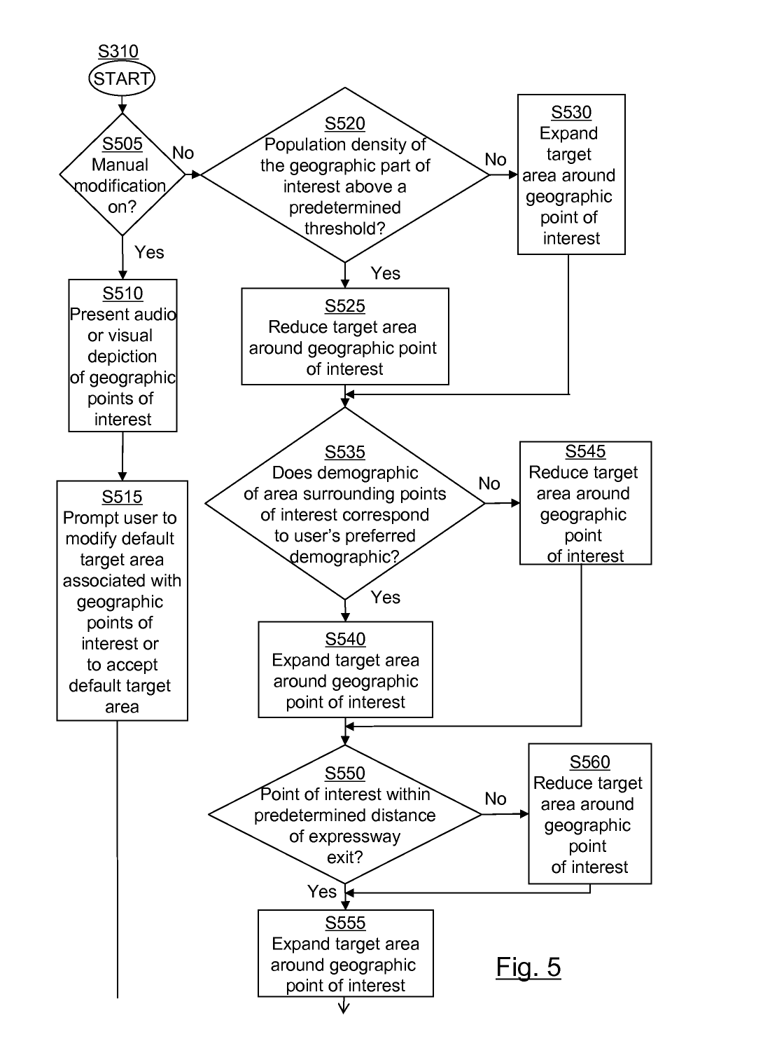

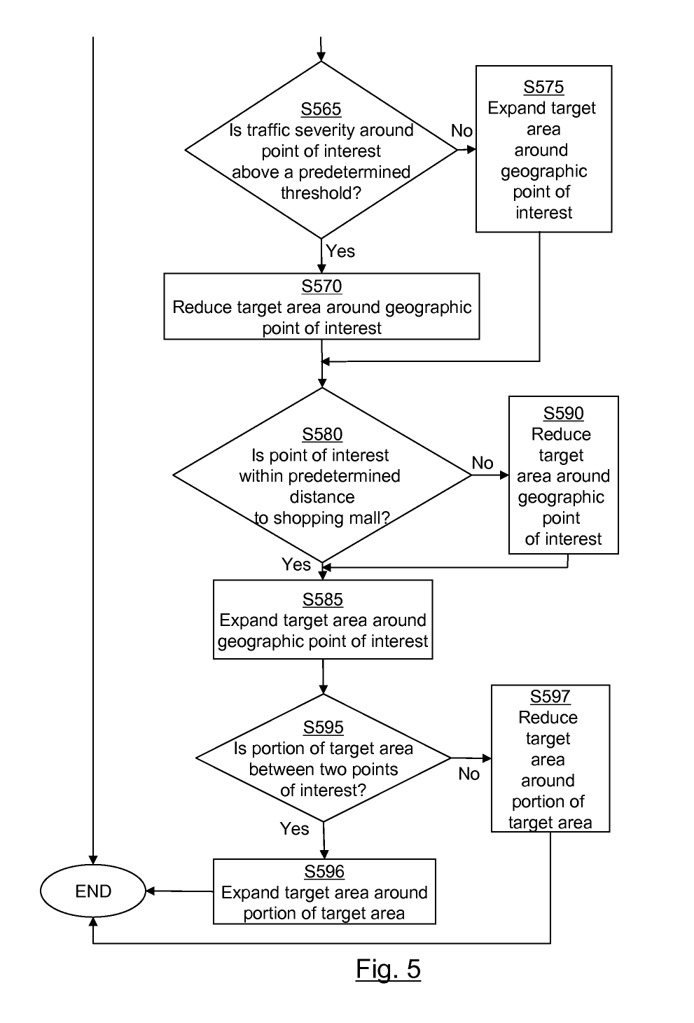

FIG. 5 illustrates a flow chart in which the target area is generated according to S310 based on the geographic points of interest that have been established in S305, as discussed above. In an embodiment, the process begins at S505, where it is determined whether the manual modification option is on. If the manual modification option is on, the process proceeds to S510, where audio or visual depictions of the geographic points of interest are presented to the user. For example, the user can view the visual depiction of the geographic points of interest on a map so the user can determine the types of manual modifications are desired to more closely tailor the target area to the user's unique travels and locations. In S515, the user device 100 prompts the user to modify the default target area associated with the geographic points of interest or to accept the default target area without modification. The default target area can include a predetermined radius surrounding the geographic point of interest, e.g., a 3-mile radius surrounding the geographic point of interest. The user can then modify the target area associated with the geographic point of interest or accept the default target area in S515. The user may wish to modify the target area based on any factor considered important to the user. For example, if the default 3-mile radius surrounding the geographic point of interest causes the target area to encompass an area of high crime, the user can modify the target area using a mouse or other input device on the interface 205 so that the high crime area is excluded from the target area. Following S515, the process according to S310 ends and the target area is established based on the target area modified or accepted by the user in S515.

If manual modification is not activated, the process proceeds to S520, wherein the automatic modification of the target area begins. It should be noted that any of the factors discussed below with respect to the automatic modification of the target area can be toggled on or off as desired by the user.

In S520, it may be determined whether the population density of the geographic point of interest is above a predetermined threshold. If the population density surrounding the geographic point of interest is above the predetermined threshold, the process proceeds to S525, wherein the target area surrounding the geographic point of interest is reduced. However, if the population density surrounding the geographic point of interest is below the predetermined threshold, the process proceeds to S530, wherein the target area surrounding the particular geographic point of interest is expanded. The reasoning for the above modification is because a user is typically more inclined to travel longer distances to reach their destination or their desired business locations when the user is traveling or located in a rural environment. Thus, S520 automatically modifies the target area according to this principle.

Once the population density of the geographic point of interest is analyzed, the process may proceed to S535, where the demographic of the area surrounding the points of interest is analyzed to determine whether it corresponds to the user's preferred demographic. If the geographic point of interest corresponds to the user's preferred demographic, the process proceeds to S540, wherein the target area is expanded around the geographic point of interest. Alternately, if the demographic of the area surrounding the points of interest does not correspond to the user's preferred demographic, the process proceeds to S545, wherein the target area around the geographic point of interest is reduced. The demographic of the geographic point of interest is analyzed because many users are more likely to travel to areas in which they share the same age, income level, or ethnic/religious background. Also, a person may enjoy food of a particular ethnicity, and thus may wish to have a target area encompass neighborhoods with restaurants associated with this ethnicity. Once the demographic surrounding the geographic point of interest has been analyzed, the process proceeds to S550.

In S550, it may be determined whether the geographic point of interest is within a predetermined distance of an expressway or highway exit. If the geographic point of interest is within a predetermined distance of an expressway or highway exit, the target area is expanded around the geographic point of interest, as depicted in S555. Otherwise, the target area around the geographic point of interest is reduced as depicted in S560. The reasoning for this analysis is because consumers tend to shop more around areas close to expressway or highway exits because the consumer can easily get to and from their destination by way of the expressway or highway located close to the business of interest.

To avoid the target area being in an area of heavy traffic, the traffic severity surrounding the geographic point of interest may be analyzed to determine whether it is above a predetermined threshold. If the traffic severity is above the predetermined threshold, the process may proceed to S570, wherein the target area is reduced in an attempt to avoid severe traffic. If the traffic severity is below the predetermined threshold, the target area will be expanded so as to encompass areas of low traffic.

After the traffic severity has been analyzed, the process may proceed to S580, where it is determined whether the geographic point of interest is within a predetermined distance to a shopping mall, under the assumption that consumers are more likely to shop in an area of high concentration of vendors, rather than in an area where the vendors are spread out and the user is required to travel more to get from one vendor to another. If the geographic point of interest is within a predetermined distance to a shopping mall, the process may proceed to S585 and expands the target area so as to encompass more areas that have a high concentration of vendors.

If the geographic point of interest is not within the predetermined distance to a shopping mall, the process may proceed to S590, wherein the target area surrounding the geographic point of interest is reduced. Finally, the process according to S310 may proceed to S595 where it may be determined whether a portion of the target area is between two geographic points of interest.

This process assumes that a consumer is more likely to purchase a product or service at a business located between two major points of their commute, e.g., between home and work. Accordingly, if the portion of the target area is located between two of the geographic points of interest, the process expands the target area around the portion located between the two points of interest at S596. If the portion is not between the two geographic points of interest, the process may reduce the target area in a region that is not located between the geographic points of interest.

Following either the manual and/or automatic analysis, the process according to S310 is complete and the target area is established for the user. Accordingly, the process according to S310 ends following the manual and/or automatic analysis of the geographic points of interest. It is noted that many of the above modifications were discussed as being made to geographic points of interest rather than to sections of the target area that are not necessarily geographic points of interest. It should be noted that any of the above manual or automatic modifications can be made either to an established geographic point of interest or a portion of the target area that is not input by the user or determined automatically by the user device 100 to be a geographic point of interest. For example, a specific portion of the target area between the user's home and work can be analyzed to determine whether that specific portion of the target area is above or below the predetermined population density threshold according to S520.

It is also noted that many of the automatic modifications assume that the user will choose either an automatic or manual modification process, but not both. However, it should be noted that the user can have sole discretion to either manually or automatically, or both manually and automatically modify his or her target area depending on factors relevant to his or her routine. In addition, the modifications can be expanded or reduced variably. For example, the user may choose to expand his or her target area by a 1-mile radius if the portion of the target area or geographic point of interest is above the predetermined threshold for the population density in accordance with S520, but may choose to expand or reduce the target area surrounding the geographic point of interest or a portion of the target area by 3 miles if the demographic of that area matches the preferred demographic of the user. It will further be appreciated that the present invention can operate with one or more of the above-described automatic or manual modifications, and not all. Accordingly, each above described automatic or manual modification is optional, exemplary and non-exhaustive.

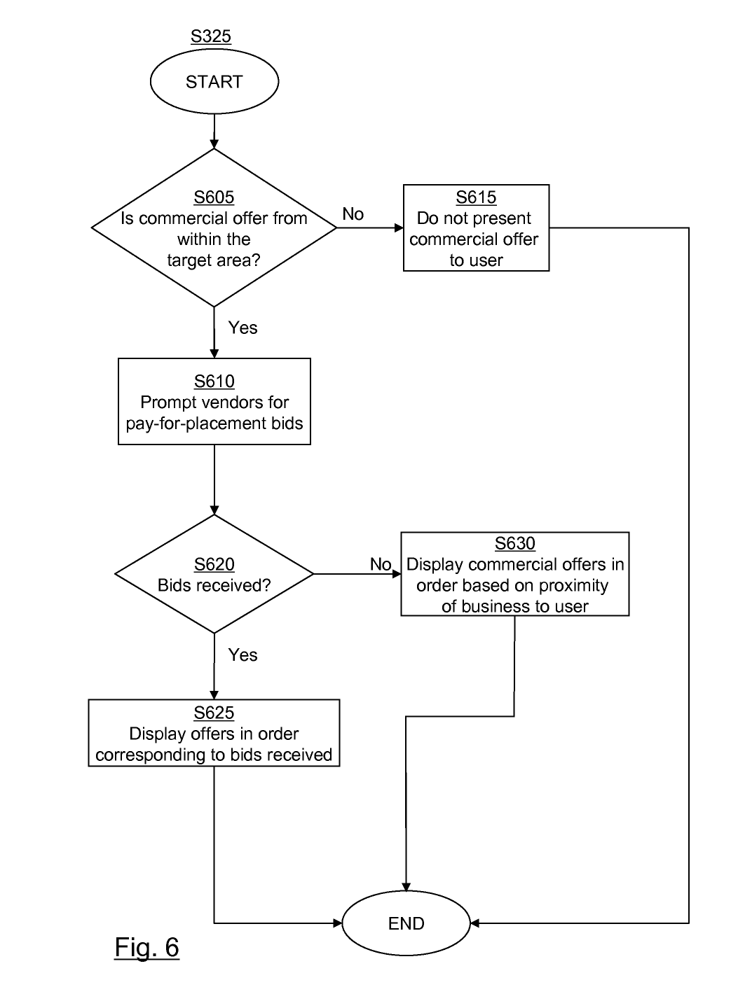

FIG. 6 discloses a flow chart depicting a more detailed illustration of the process of presenting commercial offers to a user in S325. Once the process reaches S325, a target area has already been established (in S310) and the user has been provided with commercial offers (in S315 or otherwise). The process of S325 focuses primarily on how the received commercial offers or searches are presented to the user based on a pay-for-placement methodology. The process begins at S605 in which either the user device 100 or the server 105 determines whether the commercial offer is within the target area determined in S310. If the commercial offer is within the target area, the process proceeds to S610 in which commercial offer results are displayed to the user. If the commercial offer is not within the target area, the process proceeds to S615, in which the commercial offer is not presented to the user and the process according to S325 ends.

In an embodiment, in S610, the vendors are prompted for pay-for-placement bids where the highest vendor bid will cause that particular vendor's commercial offer or business website to be placed at the top of a list of search results displayed to the user. The pay-for-placement bids may be either in the form of a flat amount of money (e.g., $1,000) or in the form of a portion of the discount offered to the user. For example, if the vendor offers a 10 dollar discount to the user, the user will receive 5 dollars off the goods or services of the vendor, while the search engine will receive the remaining five dollars as a commission for the sale. Alternatively, a “hybrid” bidding system can be employed where the vendor can bid a certain flat rate of money to have their commercial offer displayed prominently in the search results, and can have a portion of the discount paid to the search engine as an additional commission. Any combination of flat rate payments and portions of discounts can be employed without departing from the spirit and scope of the present invention.

Although FIGS. 3 and 6 illustrate vendor bids being received after the target area has been established, the vendor bids can be solicited at any time. For example, the vendors can be asked to bid within a pay-for-placement methodology for future unknown consumers, well before any target area has been determined (i.e., prior to S305 in FIG. 3). Alternately, the vendors can bid on pay-for-placement position based on an anticipated location of the user. For example, if the user is anticipated to be located near the vendor at a time in which the commercial offer is most relevant, the vendor can bid a higher amount to have the commercial offer displayed more prominently.

Following S610, the process proceeds to S620 where the user device 100, the server 105 or another device or system on the network 110 determines whether bids have been received in accordance with, for example, the pay-for-placement methodology. For example, if the user is likely to be located near an Italian restaurant during dinnertime, and several bids have been received for Italian restaurants within the relevant offer area and offer period, the offers will be displayed in an order corresponding to the bids received, as depicted in S625. Otherwise, the process proceeds to S630 if no bids have been received for the commercial offer, and offers are displayed in an order based on the proximity of the business to the user's anticipated location.

Following steps S625 and S630, the user has now obtained the commercial offers from vendors from within his or her target area or anticipated location, and the offers have been displayed or other presented to the user. Accordingly, vendors waste less money on pay-for-payment bids directed at consumers that are unlikely to conduct business with the vendor. Also, the user now has the ability to accept commercial offers within his or her target area or anticipated location and is not inundated with commercial offers from businesses located outside of his or her target area or anticipated location that would be impossible or inconvenient to accept or use.

FIGS. 7(a)-(c) shows a display of a map with specific geographic points of interest chosen manually by a user. As shown in FIG. 7(a), in this example, the user lives in the Chicago metropolitan area, and has manually chosen the Lincolnwood area as the location of his or her home. The process then prompts the user to input the location of his or her place of business, which is in the downtown loop area of Chicago, as shown in FIG. 7(b). The user can then input any other location as a geographic point of interest, e.g., the school of the children of the user, as shown in FIG. 7(c).

As shown in FIG. 8(a), the user can modify the target area by using an input device (e.g., a computer mouse) and dragging the default radius, shape and/or size on any one of the geographic points of interest. As shown in this example, the user has decided to modify the target area associated with the user's work. The user has decided to shrink the target area surrounding this geographic point of interest to exclude the southern end thereof, which the user is less likely to be on a regular basis. Of course, any other modifications, including enlarging and shrinking the target area or modifying the shape, can be performed by the user based on any factor the user deems relevant. As shown in FIG. 8(b), the target areas surrounding the geographic points of interest have merged in accordance with the factors determined in S310 to form a custom target area for the individual user.

It is noted that many of the above examples provide a target area associated with the user's home and work locations, which would generally be located within the same metropolitan area. However, the user may create a separate profile for a separate metropolitan area, e.g., if the user has a vacation home in another metropolitan area. For example, if the user lives in New York, but regularly vacations in Miami, the user may create a separate profile for his or her Miami home with its own set of geographic points of interest and its own target areas. The separate profile can temporarily replace and suspend the original target area or can maintain both of the target areas simultaneously. By suspending the original target area, the user can avoid receiving commercial offers from within his or her regular shopping area while temporarily absent.

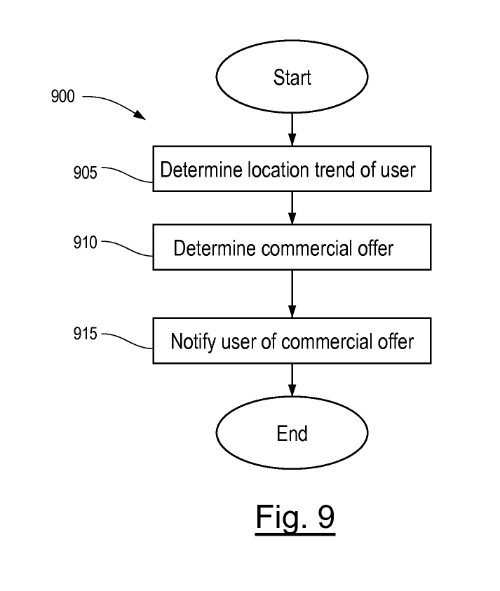

FIG. 9 is a flowchart illustrating an embodiment of the present application in which time-sensitive or time-specific commercial offers are transmitted to a user that has entered an area associated with the vendor during the time in which the commercial offer is most relevant or available. For example, the commercial offer can be a breakfast coupon, which is most relevant during the morning period. The method can thus determine whether the user is likely to be located within an area associated with the vendor submitting the offer at the time of day in which the offer is most relevant (for example, if the user would likely be traveling from his home location to his work location), and send the commercial offer to the user via automatic means such as, for example, push notifications. Alternately, the commercial offer can be sent at any other time such as, for example, the night before the user travels to work.

As shown, the process 900 of FIG. 9 begins and a location trend of the user is determined S905. That is, the daily, weekly or otherwise periodic routine of the user can be ascertained so an anticipated location of the user can be estimated at future points in time. Once the location trend is established S905, the system can determine one or more commercial offer that coincides with the time and location routine S910. Following this step, the commercial offer can be provided to the user based on the anticipated location of the user at a given time in which the offer is most relevant 915.

The location trend of the user can be determined S905 in any way. For example, the location trend can be determined by establishing a target area as described above with respect to FIG. 3 in order to determine a work and home location, and the system can thereafter estimate that the user is likely to be located near the work location during the morning hours under the assumption that people typically travel to work during the hours of 7:00 am-9:00 am. Alternately, the system can periodically record the location of the user and determine that the user acts out a predictable routine. The system can also determine the location trend by statistically analyzing the recorded locations and determining a statistical score that indicates the likelihood that the user will be located at a particular location at a particular point in time. The system could also determine when the user is likely leaves his or her home to begin a trip to work (e.g. early morning hours), for example, and can estimate the time that the user will likely be located at or near the vendor's location. Any other manner of estimating the future location of the user can be employed without departing from the spirit and scope of the present application.

A location trend can also be validated by using GPS functionality, where a mobile phone application can record the GPS coordinates of a user at predetermined or user-designated times. The GPS recording may be stronger in an area that is frequently visited by the user, and vendors can use this information to provide better coupon discounts to users who have an increased presence in the location of the vendor in that area. For example, a user that is frequently located near a specific restaurant may receive a better discount offer for that restaurant based on the GPS recording the increased frequency of the user in that area. The user can either receive a custom discount offer or be included within a specific group of users that have a predetermined presence near the restaurant, for example. Vendors can increase, decrease, or eliminate the discount based on any factor they deem relevant to the purchasing habits of the users. Any other manner of verifying the target area can be implemented without departing from the spirit and scope of the present application.

In step S915, commercial offers can be transmitted to users in a time-released fashion so as to provide a sustainable form of business for the vendor. For example, coupons or advertisements can be transmitted to a subset of users where the exact price and amount of products sold are determined prior to the deal being announced to the customers. Rather than transmitting the deal to all of the potential customers at the same time, the time-released deal system transmits the deal separately to small groups of customers over a period of time in step S915. The vendor is less likely to be overwhelmed with the influx of business and will avoid personnel or inventory issues associated with the extra business.

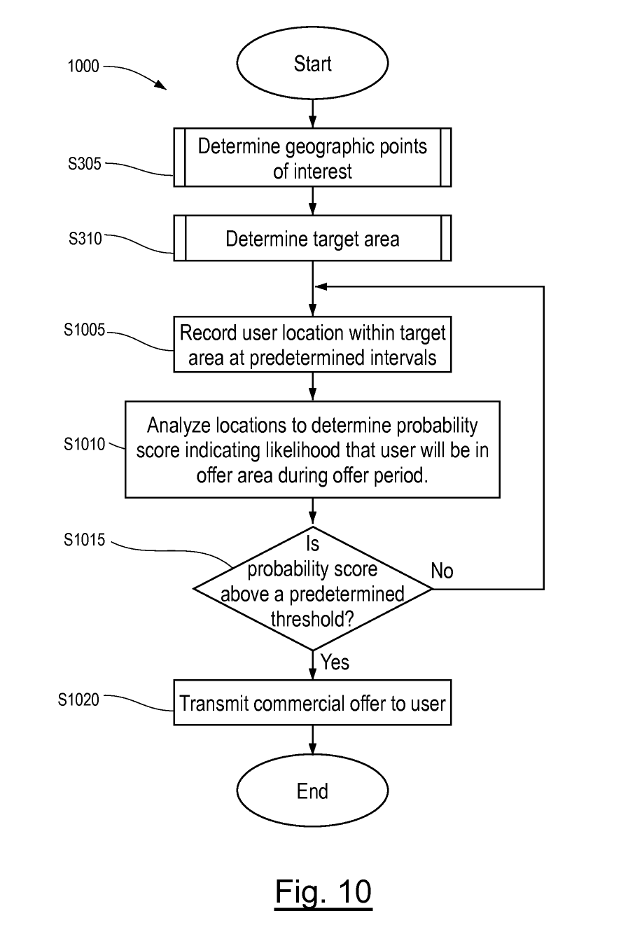

FIG. 10 illustrates a process by which a user can obtain a commercial offer based on a repeated routine. As with the other methods and systems of this application, the repeated routine can be either a daily routine (such as the location of the user during predetermined times of day) or can be a weekly, monthly, or otherwise periodic routine where the process 1000 determines a likely location of the user at a specific time or at a specific point during the periodic routine. The process 1000 can then transmit commercial offers to the user that are specifically targeted for the times that the user is likely to be located in the offer area at the anticipated time. For example, a breakfast coupon offer can be submitted from a vendor located at exit 48B on interstate 94 in Chicago based on data that has been previously recorded indicating that the user is likely to be located at or near that same exit during breakfast hours, or the user is otherwise anticipated to be at or near the location during breakfast hours.

As shown in FIG. 10, the process 1000 begins at S305 and determines a geographic point of interest and proceeds to step S310 where a target area is determined, similar to the method of FIG. 3. The target area may be used later to determine relevant vendors that would be interested in soliciting the user with commercial offers. The process 1000 then proceeds to step S1005, where the user location is recorded at predetermined intervals. For example, the location of the user can be recorded every day at a predetermined time of day based on a GPS sensor provided in the user's smart phone so as to establish a “location trend.” Alternately, the location of the user can be determined on a weekly or yearly basis, or can be determined once a week (e.g., noon on Saturdays) to determine whether the user forms specific weekly habits or routines.

The recorded locations are then analyzed to determine a probability score indicating the likelihood that the user will be located in the offer area during the offer period S1010. If the probability score is above a predetermined threshold, the process proceeds to step S1020 where the commercial offer is transmitted to the user, and the process 1000 ends. If the probability score is below the predetermined threshold, the process reverts back to step S1005, where the user location is again recorded and commercial offers are sought out that match the user's time and location-based routine.

Step S1015 can determine the probability score based on past user locations and the times respectively associated with those locations. For example, based on the user locations and times recorded on a periodic basis in step S1005, the process 1000 can determine that the user travels past a particular restaurant at least four times a week between the hours of 8:00 am, and 9:00 am. The process 1000 can then estimate that the user is likely to pass by the same restaurant in the future between 8:00 am and 9:00 am, and would be a targeted candidate for a coffee or breakfast purchase at the restaurant. As such, the process 1000 can transmit commercial offers for breakfast or coffee discounts to the user at any time to induce the user into purchasing breakfast at a location that is convenient to the user based on the user's routine.

The location trend can be considered valuable information to outside vendors. As a result, the process 1000 may, with appropriate privacy filters, provide data representing the location trend of the user to the vendor or to outside vendors. For example, the process 1000 can submit the location trend to outside marketers that can use the location trend to specifically target the user with relevant advertisements.

Commercial offers for the embodiments of FIGS. 9 and 10 can be most relevant during particular hours. However, it should be appreciated that such commercial offers are not necessarily transmitted during those hours. For example, a user can receive commercial offer for a breakfast coupon at night, and use the breakfast coupon during the morning hours. The commercial offers can thus be transmitted at any time without departing from the spirit and scope of the present application.

The matter set forth in the foregoing description and accompanying drawings and examples is offered by way of illustration only and not as a limitation. More particular embodiments have been shown and described, and it will be apparent to those skilled in the art that changes and modifications may be made without departing from the broader aspects of Applicant's contribution. The actual scope of the protection sought is intended to be defined in the following claims when viewed in their proper prospective based on the prior art.

1. A method of providing a commercial offer of a vendor comprising:
establishing, with a processor, a location trend of a user representing a plurality of estimated recurring periods of time when the user will be located within an anticipated location;
determining a commercial offer that coincides with the location trend; and
providing the commercial offer to the user based on the location trend,
wherein goods or services associated with the commercial offer can be obtained only during the estimated recurring periods of time.

2. (canceled)

3. The method of claim 1, further comprising:
establishing a geographic point of interest of the user; and
determining a target area based on the geographic point of interest, wherein the commercial offer is associated with the target area.

4. The method of claim 1, further comprising recording a location of the user at substantially a same time on a plurality of days to establish the location trend.

5. The method of claim 1, further comprising notifying the vendor associated with the commercial offer of the location trend.

6. The method of claim 5, wherein the step of determining the location of a user is performed by a GPS sensor.

7. The method of claim 3, wherein the estimated recurring time periods are based on an estimated time in which the user will be located near specific geographic points of interest.

8-13. (canceled)
